(19) United States
(12) Patent Application Publication
(10) Pub. No.: US 2010/0213124 A1
(43) Pub. Date: Aug. 26, 2010

(54) SUBMERGED MEMBRANE SEPARATION APPARATUS AND METHOD FOR OPERATION THEREOF

(75) Inventors: Hiroo Takabatake, Shiga (JP); Asami Naruse, Shiga (JP); Kazuya Sugita, Shiga (JP); Atsushi Kitanaka, Shiga (JP)

Correspondence Address: RATNERPRESTIA, P.O. BOX 980, VALLEY FORGE, PA, 19482, US

(73) Assignee: Toray Industries, Inc, Tokyo (JP)

(21) Appl. No.: 12/599,181

(22) PCT Filed: Apr. 21, 2008
(86) PCT No.: PCT/JP2008/057655

§ 371 Date: Nov. 6, 2009

(30) Foreign Application Priority Data
May 10, 2007 (JP) 2007-125300
Oct. 10, 2007 (JP) 2007-264096

(51) Int. Cl. B01D 63/08; B01D 65/02; C02F 1/44; B01D 65/08

(52) U.S. Cl. 210/636; 210/220

(57) ABSTRACT

A submerged membrane separation apparatus is provided that includes a separation membrane module and fine bubble diffusing tubes placed vertically below the module that can evenly and uniformly produce fine bubbles from vertically below the separation membrane module, even when the separation membrane module is large. The apparatus includes: a plurality of fine bubble diffusing tubes placed vertically below the separation membrane module; and a plurality of gas supply pipes for supplying gas to the fine bubble diffusing tubes, wherein the plurality of gas supply pipes are opposed to each other so that a region vertically below the separation membrane module is held between them, the plurality of fine bubble diffusing tubes are connected to the gas supply pipes and extend in a direction intersecting with the membrane surface of the separation membrane element, and the fine bubble diffusing tubes opposed to one another have front ends placed adjacent to one another or have front end portions overlapping one another.

### TECHNICAL FIELD

The invention relates to a submerged membrane separation apparatus suitable for use in treatment of polluted water such as sewage, excrement, or industrial wastewater, and to a method for operation thereof. More specifically, the invention relates to an improvement in the structure of diffuser tubes in such a submerged membrane separation apparatus.

### BACKGROUND ART

FIG. 15 shows a submerged membrane separation apparatus submerged in a treatment tank, which is a conventional water treatment apparatus using membranes to filter polluted water such as sewage, excrement, or industrial wastewater. In FIG. 15, the submerged membrane separation apparatus submerged in a liquid to be treated in a treatment tank 1. A separation membrane module 2 includes a plurality of flat sheet-shaped filtration membranes arranged in parallel with the membrane surfaces parallel to one another. The separation membrane module 2 is provided with permeate outlets 12, which communicate with an effluent piping 13 and a suction pump 14.

The opening of an untreated liquid supply pipe 11 is located above the treatment tank 1. The suction pump 14 is operated to generate a driving force for filtration so that the liquid in the treatment tank is filtered with the separation membranes placed in the separation membrane module 2. The filtrate is discharged to the outside of the system through the permeate outlets 12 and the effluent piping 13.

Diffuser tubes 3 are placed under the separation membrane module. During the filtration operation, air is supplied from a gas supply unit 7 to the diffuser tubes through a gas supply pipe 5 and branch pipes 6 so that the air is discharged from the diffusing holes of the diffuser tubes into the treatment tank (aeration tank) 1. An upward-moving stream of a gas-liquid mixture is generated by the air lift effect of the issuing air. The upward-moving stream of the gas-liquid mixture and bubbles act as cleaning flows on the surfaces of the filtration membranes, so that the adhesion or deposition of a fouling cake layer onto the membrane surfaces is suppressed for a stable filtration operation (see Patent Literature 1).

Relatively coarse bubbles are effective in increasing the cleaning flow effect on the membrane surfaces, and therefore, coarse bubble-generating diffuser tubes have been used. It is also proposed that fine bubble-generating diffuser tubes should be used to reduce the amount of the diffused gas. Even in such a case, the fine bubble diffusing tubes are used in combination with coarse bubble diffusing tubes so that coarse bubbles can act on the membrane surfaces (see Patent Literatures 2 and 3). In such an apparatus, diffuser tubes having small diffusing holes (fine bubble diffusing tubes) or membrane type diffuser plates are used, and such diffusers are placed at a predetermined location under the separation membrane module.

In general, fine bubble diffusing tubes are also used in a diffuser system for supplying oxygen to microorganisms in an activated sludge liquid in a treatment tank. As shown below the separation membrane module in FIG. 15, for example, known fine bubble diffusing tubes are so configured that air supplied from a single main gas-supply pipe 5 is guided to a plurality of branch pipes 6 placed on both sides of the pipe 5 and diffused from fine diffusing holes formed in the surfaces of the branch pipes (see Patent Literature 4). When the fine bubble diffusing tubes have, such a structure, fine bubbles are not diffused from the central region where the main gas-supply pipe 5 is located. When oxygen is supplied to an activated sludge liquid, such an unevenness of gas diffusion has no problem. However, when such a diffuser is placed under a separation membrane module as shown in FIG. 15, the air lift effect is hardly produced at the central portion of the diffuser where no fine bubbles are diffused, so that the cleaning flow effect on the membrane surfaces may be very low at the central portion. As a result, a problem occurs in which membrane surface cleaning is insufficient in the central portion of the separation membrane module, as compared with that in the other portion, so that the filtration function of the separation membrane is significantly reduced in the central portion.

Patent Literature 1: Japanese Patent Application Laid-Open (JP-A) No. 10-296252

Patent Literature 2: JP-A No. 2001-212587

Patent Literature 3: JP-A No. 2002-224685

Patent Literature 4: JP-A No. 2005-081203

### DISCLOSURE OF THE INVENTION

### Problems to be Solved by the Invention

An object of the invention is to solve the problem with the conventional technique described above and to provide a submerged membrane separation apparatus that includes a separation membrane module and fine bubble diffusing tubes placed vertically below the module and can evenly and uniformly produce fine bubbles from vertically below the separation membrane module, even when the separation membrane module is large.

### Means for Solving the Problems

To achieve the object, the submerged membrane separation apparatus of the invention has the features described below.

(1) A submerged membrane separation apparatus submerged in a liquid to be treated in a treatment tank, including:

a separation membrane module including a plurality of separation membrane elements each having a flat membrane as a separation membrane, the plurality of separation membrane elements being arranged in parallel with their membrane surfaces being parallel to one another;

a plurality of fine bubble diffusing tubes placed vertically below the separation membrane module; and

a plurality of gas supply pipes for supplying gas to the fine bubble diffusing tubes, wherein

the plurality of gas supply pipes are opposed to each other so that a region vertically below the separation membrane module is held between them,

the plurality of fine bubble diffusing tubes are connected to the gas supply pipes and extend in a direction intersecting with the membrane surface of the separation membrane element, and

the fine bubble diffusing tubes opposed to one another have front ends placed adjacent to one another or have front end portions overlapping one another.

(2) The submerged membrane separation apparatus according to item (1), wherein

the plurality of fine bubble diffusing tubes connected to the opposed gas supply pipes, respectively, are arranged in a region vertically below the separation membrane module so that their longitudinal directions are substantially aligned with a straight line,

the front ends of the fine bubble diffusing tubes opposed to one another are placed adjacent to one another, and

the plurality of fine bubble diffusing tubes are arranged in rows in each of which the fine bubble diffusing tubes have different lengths and used in combination so that their front ends are not aligned between the rows.

(3) The submerged membrane separation apparatus according to item (2), wherein the front ends of the fine bubble diffusing tubes substantially aligned with the straight line are staggered every row or every two or more rows.

(4) The submerged membrane separation apparatus according to item (1), wherein

the plurality of fine bubble diffusing tubes connected to the opposed gas supply pipes, respectively, extend in a substantially horizontal direction in the region vertically below the separation membrane module, and

the fine bubble diffusing tubes opposed to one another have front end portions partially overlapping one another.

(5) The submerged membrane separation apparatus according to item (1), wherein the difference between the sums of the longitudinal lengths of the fine bubble diffusing tubes connected to the opposed gas supply pipes is 10% or less.

(6) The submerged membrane separation apparatus according to item (1), wherein the plurality of fine bubble diffusing tubes are arranged at intervals of 80 to 200 mm in a direction perpendicular to their longitudinal axes.

(7) The submerged membrane separation apparatus according to item (1), wherein the gas is supplied from separate gas supply units to the opposed gas supply pipes, respectively.

(8) The submerged membrane separation apparatus according to item (1), wherein the fine bubble diffusing tube comprises at least a cylindrical supporting tube and an elastic sheet having fine slits, wherein the elastic sheet is so placed that the periphery of the supporting tube is covered with the elastic sheet, and the fine bubble diffusing tube has a function such that when gas is supplied to between the elastic sheet and the supporting tube, the fine slits of the elastic sheet are opened so that fine bubbles can be generated outside the diffusing tube.

(9) The submerged membrane separation apparatus according to item (1), further including a frame that is placed under the separation membrane module so as to support the separation membrane module, wherein

the fine bubble diffusing tubes are placed inside the frame, and

the ratio B/A is from 0.8 to 5.0, wherein B is the area of the openings of sides of the space surrounded by the frame, the sides being parallel to the direction of the arrangement of the membrane elements and located above the fine bubble diffusing tubes, and A is the area of the openings of the upper side of the membrane separation module.

(10) The submerged membrane separation apparatus according to item (1), wherein the separation membrane is a flat membrane including a base material layer including a nonwoven fabric and a porous separation-functional layer made of polyvinylidene fluoride and formed on the base material layer, wherein the porous separation-functional layer has an average pore size of 0.2 μm or less, and the membrane has a surface roughness of 0.1 μm or less.

(11) A method for operating a submerged membrane separation apparatus, including:

submerging the submerged membrane separation apparatus according to item (1) in a liquid to be treated in a treatment tank;

performing aeration from the fine bubble diffusing tubes; and

performing a membrane filtration operation, wherein

the flow rate of the aeration per horizontal cross-sectional area of the separation membrane module, supplied to the fine bubble diffusing tubes, is 0.9 m³/m²/minute or more.

### EFFECTS OF THE INVENTION

According to the invention, even a submerged membrane separation apparatus with a large-scale separation membrane module allows uniform cleaning with fine bubbles evenly acting on every membrane surface of every separation membrane, a continuation of a stable membrane filtration operation, and an increase in the life of the separation membrane module, because the fine bubble diffusing tubes with the specific structure are placed vertically below the separation membrane module.

In addition, the fine bubble diffusing tubes having the specific structure according to the invention can be evenly placed over the region vertically below the separation membrane module, even when they are not long.

### BRIEF DESCRIPTION OF THE DRAWINGS

FIG. 1 is a schematic perspective view showing an embodiment of the membrane separation apparatus of the invention;

FIG. 2 is a longitudinal cross-sectional view along the longitudinal central axis a of a fine bubble diffusing tube used in the invention;

FIG. 3 is a top view showing fine bubble diffusing tubes used in another embodiment of the invention;

FIGS. 4(a) and 4(b) are a top view and a side view respectively, each showing fine bubble diffusing tubes used in a further embodiment of the invention;

FIG. 5 is a schematic perspective view showing two adjacent separation membrane elements in a separation membrane module of the invention;

FIGS. 6(a), 6(b) and 6(c) are a front view, a side view and an A-A cross-sectional view respectively, each showing a membrane separation apparatus in Example 1;

FIGS. 7(a), 7(b) and 7(c) are a front view, a side view and an A-A cross-sectional view respectively, each showing a membrane separation apparatus in Example 2;

FIG. 8 is a schematic perspective view showing a further embodiment of the membrane separation apparatus of the invention;

FIG. 9(a) is a schematic diagram (partially broken cross-sectional view) of the membrane separation apparatus of FIG. 8 viewed from a side parallel to the direction of the arrangement of the membrane elements 2;

FIG. 9(b) is a schematic cross-sectional view of the membrane separation apparatus of FIG. 8 viewed from a side perpendicular to the direction of the arrangement of the membrane elements 2;

FIG. 10 is a schematic diagram showing a waste water treatment apparatus for a membrane separation activated sludge process used in Examples 3 and 4;

FIG. 11 is a cross-sectional view schematically showing the surface portion of a separation membrane;

FIG. 12 is a graph showing the relationship between the surface roughness (RMS) of a separation membrane and the non-membrane-permeable substance separation coefficient ratio;

FIG. 13 is a graph showing the relationship between the average pore size of a separation membrane and the filtration resistance coefficient ratio;

FIG. 14 is a schematic diagram of a membrane filtration evaluation system used to evaluate the filtration performance of a separation membrane;

FIG. 15 is a schematic perspective view showing an exemplary conventional membrane separation apparatus; and

FIG. 16 is a schematic diagram of a submerged membrane separation apparatus used in Example 5, which is viewed from the top to show the positional relation between membrane elements and fine bubble diffusing tubes.

### DESCRIPTION OF REFERENCE SYMBOLS

In the drawings, reference symbol 1 represents a treatment tank (aeration tank), 2 a separation membrane module, 3 diffuser tubes, 4 (4R, 4L) fine bubble diffusing tubes, 4a short fine bubble diffusing tubes, 4b long fine bubble diffusing tubes, a the longitudinal central axis of a fine bubble diffusing tube, 5 (5R, 5L) gas supply pipes, 6 (6R, 6L) branch pipe portions, 7a gas supply unit (blower), 8 an on-off valve for gas supply, 9a main gas-supply pipe, 11 an untreated liquid supply pipe, 12 permeate outlets, 13 an effluent piping, 14a suction pump, 16 an elastic sheet, 17a supporting tube, 18 ring-shaped fixing members, 19a through hole, 22 (22-02 to 22-99) separation membrane elements, 23a membrane surface part (membrane surface), 24a height corresponding to a surface roughness, 25a width corresponding to an average pore size, 31a raw water supply pump, 32a denitrification tank, 33a sludge circulating pump, 34a sludge drawing pump, 35a casing, 36a frame, k a horizontal distance between diffusing tubes, 41a space between elements, 42 one side for the area B of openings, which is parallel to the direction of the arrangement of the membrane elements 2 and placed above the diffuser tubes 3, 43 bubbles, 44 and 45 turning flows.

### BEST MODE FOR CARRYING OUT THE INVENTION

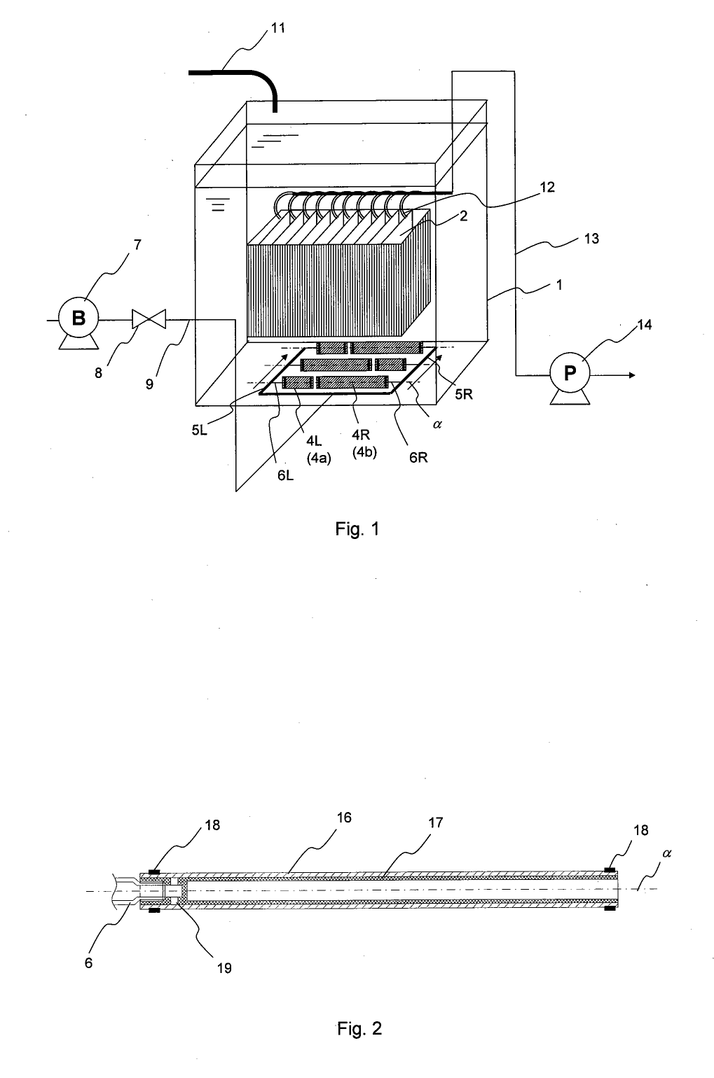

The submerged membrane separation apparatus according to the invention is described below based on some embodiments shown in FIGS. 1, 2, 3, 4, and so on.

FIG. 1 is a schematic perspective view showing one embodiment of the submerged membrane separation apparatus according to the invention. In FIG. 1, the submerged membrane separation apparatus is submerged in a liquid to be treated in a treatment tank 1. The submerged membrane separation apparatus includes: a separation membrane module 2 including a plurality of flat sheet-shaped filtration membranes arranged in parallel with their surfaces parallel to the vertical direction; and an effluent piping 13 in communication with a permeate outlet 12 of each element in the separation membrane module 2. The opening of an untreated liquid supply pipe 11 is located above the treatment tank 1. The pressure in the effluent piping 13 is reduced by operating a suction pump 14 to generate a driving force for filtration so that the liquid in the treatment tank is filtered with the separation membranes. The filtrate is discharged to the outside of the system through the effluent piping 13.

The treatment tank 1 may be made of any material that makes it possible to store waste water and an activated sludge mixture liquid. Preferably, however, a concrete tank, a fiber-reinforced plastic tank or the like is used.

The suction pump 14 attached to the effluent piping 13 may be of any type that makes it possible to reduce the pressure in the effluent piping 3. Alternatively, the pressure in the effluent piping 13 may be reduced using a water head pressure difference caused by siphonage, in place of the suction pump 14.

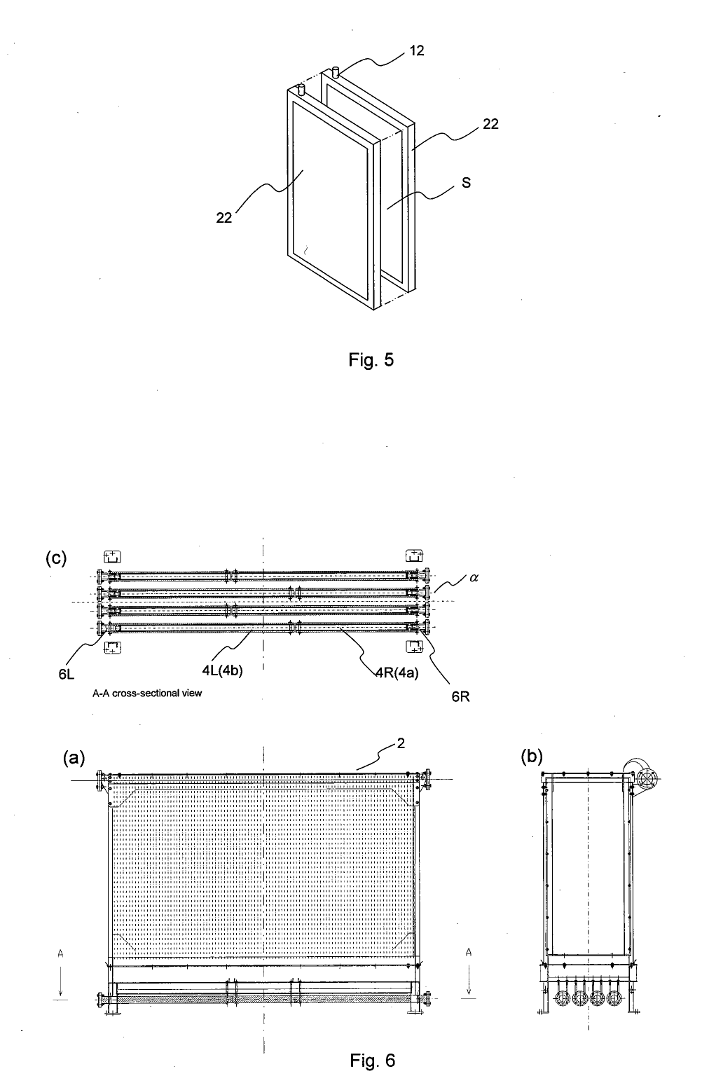

The separation membrane module 2 has a plurality of separation membrane elements 22 arranged in parallel with the membrane surfaces parallel to the vertical direction. The separation membrane element 22 has a flat sheet-shaped separation membrane. For example, the separation membrane element to be used may be configured to include a frame made of a resin, metal or the like, flat sheet-shaped separation membranes provided on both of the front and back sides of the frame, and an effluent outlet that is formed at an upper portion of the frame to communicate with the internal space surrounded by the separation membranes and the frame. FIG. 5 (a schematic perspective view) shows adjacent two pieces of the separation membrane elements 22. A predetermined space is provided between the adjacent separation membrane elements 22, and an upward-moving stream of the liquid to be treated, specifically an upward-moving stream of a fluid mixture of bubbles and the liquid to be treated, flows through the space S between the membranes. In the apparatus structure according to the invention, gas-diffusing holes can be evenly provided over regions vertically below all the spaces S between the membranes, and a stream of a gas-liquid mixture containing fine bubbles can be allowed to flow through all the spaces S between the membranes, so that the fine bubbles can evenly act on the membrane surfaces.

To increase the filtration area per volume of the separation membrane module 2, it is preferred that the distance between the separation membrane elements 22 should be narrowed so that more separation membrane elements 22 can be placed. However, if the distance between the membranes is too short, the fine bubbles or the gas-liquid mixture stream cannot sufficiently act on the membrane surface of the separation membrane element 22, so that membrane surface cleaning may be insufficient to rather reduce the filtration performance. For efficient filtration, therefore, the distance between the membranes is preferably from 1 to 15 mm, more preferably from 5 to 10 mm.

To improve the handleability or physical durability of the separation membranes, for example, the separation membrane element 22 has a flat membrane element structure in which the separation membranes are placed on both of the front and back sides of a frame or a flat plate with their periphery bonded and fixed thereto. The details of the flat membrane element structure are not particularly limited. For example, the flat membrane element structure may have a filtrate flow path member interposed between the flat plate and the filtration membrane. In an embodiment of the invention, such a flat membrane element structure is preferably used, because a high stain-removing effect can be produced by a shear force, when a flow rate is applied parallel to the membrane surface in such a flat membrane element structure.

A plurality of fine bubble diffusing tubes 4 (4L, 4R) are placed vertically below the separation membrane module 2. The fine bubble diffusing tubes 4 are connected to gas supply pipes 5 (5L, 5R) through branch pipe portions 6 (6L, 6R), respectively. The gas supply pipes 5 are arranged opposite to each other so that the region vertically below the separation membrane module is held between them. Specifically, in FIG. 1, the fine bubble diffusing tubes 4L, 4R branch from the left and right gas supply pipes 5L, 5R through the branch pipe portions 6L, 6R and extend in a direction (horizontal direction) intersecting with the membrane surfaces.

In FIG. 1, the front end portions of the fine bubble diffusing tubes 4L, 4R are located adjacent to one another, and fine bubble diffusing tubes with different lengths are placed in combination so that their front ends are not aligned between the rows. Specifically, the fine bubble diffusing tubes placed in the first row from the front in FIG. 1 include a short fine-bubble-diffusing tube 4a, which corresponds to the fine bubble diffusing tube 4L extending from the left side, and a long fine-bubble-diffusing tube 4b, which corresponds to the fine bubble diffusing tube 4R extending from the right side, so that their front ends are located more on the left side. The fine bubble diffusing tubes placed in the second row from the front include a long fine-bubble-diffusing tube extending from the left side and a short fine-bubble-diffusing tube extending from the right side, so that their front ends are located more on the right side. In the third row from the front, the front ends of the fine bubble diffusing tubes are located more on the left side similarly to those in the first row. In the case shown in FIG. 1, therefore, fine bubble diffusing tubes with different lengths are used in combination so that the front ends of the fine bubble diffusing tubes are not aligned between a plurality of rows in which the fine bubble diffusing tubes are arranged.

Referring to FIG. 1, in the membrane filtration operation, an on-off valve 8 is opened so that air supplied from a gas supply unit 7 is allowed to flow into a main gas-supply pipe 9 and the gas supply pipes 5R, 5L, and finally, the air is supplied to the fine bubble diffusing tubes 4R, 4L through the branch pipes 6R, 6L. The air is discharged from the fine gas diffusing holes in the surfaces of the fine bubble diffusing tubes 4R, 4L, so that fine bubbles are produced in the liquid to be treated in the treatment tank (aeration tank) 1. An upward-moving stream of a gas-liquid mixture generated by the air lift effect of the issuing fine bubbles and the fine bubbles act as cleaning flows on the surfaces of the separation membranes, so that the deposition of fouling materials on the membrane surfaces and the production of a fouling cake layer can be suppressed during the membrane filtration.

The gas supply unit 7 has the function of supplying gas to the main gas-supply pipe 9 and the fine bubble diffusing tubes 4a, 4b downstream thereof and may typically include a compressor, a fan, a cylinder, or the like. The on-off valve (valve) 8 attached to the main gas-supply pipe 9 may be of an opening/closing type or a switching type, as long as it can control the gas flow in the main gas-supply pipe 9 when it is turned on or off.

For example, the fine bubble diffusing tube to be used may have the structure shown in FIG. 2. Because of its structure, the longer the diffusing tube, the greater the pressure loss for the bubble generation, so that it tends to be hard to diffuse a uniform amount of bubbles in the longitudinal direction. When the separation membrane module is a large-scale module having a large number of separation membrane elements, it is difficult to form and place a fine bubble diffusing tube that has a length corresponding to the distance between both ends of the large-scale module and makes it possible to diffuse a uniform amount of bubbles in its longitudinal direction. In an embodiment of the invention, however, fine bubbles can be produced evenly and uniformly, even when fine bubble diffusing tubes are placed vertically below a large-scale separation membrane module, because the apparatus includes: a plurality of gas supply pipes that are opposed to each other so that the region vertically below the separation membrane module is held between them; and a plurality of fine bubble diffusing tubes that are connected to the gas supply pipes and arranged so as to extend in a direction intersecting with the membrane surface of the separation membrane element and arranged so that the fine bubble diffusing tubes opposed to one another have front ends placed adjacent to one another or have front end portions overlapping one another.

As shown in FIG. 1, for example, the fine bubble diffusing tubes 4L, 4R are paired and arranged so that their longitudinal central axes a are substantially aligned with the same straight line, and the front ends of the opposed fine bubble diffusing tubes are placed adjacent, to each other. In such a structure, the fine bubble diffusing tubes adjacent to each other preferably differ in length, and the front end portions are preferably arranged in such a way that they are staggered. Concerning the term “staggered,” an example of the way to arrange front end portions in a staggered manner is as follows. The fine bubble diffusing tubes 4R connected to the right gas supply pipe 5R through the branch pipe portions 6R are a long fine-bubble-diffusing tube 4b, a short fine-bubble-diffusing tube 4a and a long fine-bubble-diffusing tube 4b, which are placed in this order from the front, and the fine bubble diffusing tubes 4L connected to the left gas supply pipe 5L through the branch pipe portions 6L are a short fine-bubble-diffusing tube 4a, a long fine-bubble-diffusing tube 4b and a short fine-bubble-diffusing tube 4a, which are placed in this order from the front, so that the front end portions are staggered. When the fine bubble diffusing tubes are arranged in this manner, gas-diffusing holes can be distributed over regions vertically below the spaces between the separation membrane elements so that bubbles can be introduced into all the spaces between the separation membrane elements to make sufficient cleaning of the membrane surfaces possible.

The fine bubble diffusing tube for use in the apparatus of the invention preferably has a longitudinal length of 0.4 to 1.2 m, more preferably 0.6 to 1.0 m. If the fine bubble diffusing tube is too long, it can be difficult to uniformly generate bubbles from all the gas-diffusing holes formed in the surface of the diffusing tube. If it is too short, it can be difficult to efficiently supply bubbles to the membrane surfaces of all the membrane elements. The longitudinal length of the fine bubble diffusing tube corresponds to the length of the surface portion (gas-diffusing surface portion) from which fine bubbles are diffused.

When a plurality of fine bubble diffusing tubes are connected to each of opposed gas supply pipes, the sum of the longitudinal lengths of the fine bubble diffusing tubes connected to one gas supply pipe and the sum of the longitudinal lengths of the fine bubble diffusing tubes connected to the other gas supply pipe are preferably the same or as close as possible to each other. Specifically, the difference between the sum of the longitudinal lengths of the fine bubble diffusing tubes connected to one gas supply pipe and the sum of the longitudinal lengths of the fine bubble diffusing tubes connected to the other gas supply pipe is preferably 10% or less, more preferably 5% or less. The value of the difference between the sums is calculated using the smaller sum as the denominator. The longer the fine bubble diffusing tube, the greater the pressure loss for the bubble generation. Therefore, if there is a difference of more than 10% between the sums of the longitudinal lengths of the fine bubble diffusing tubes connected to the gas supply pipes, the amounts of the bubbles generated from the diffusing tubes may tend to be unbalanced.

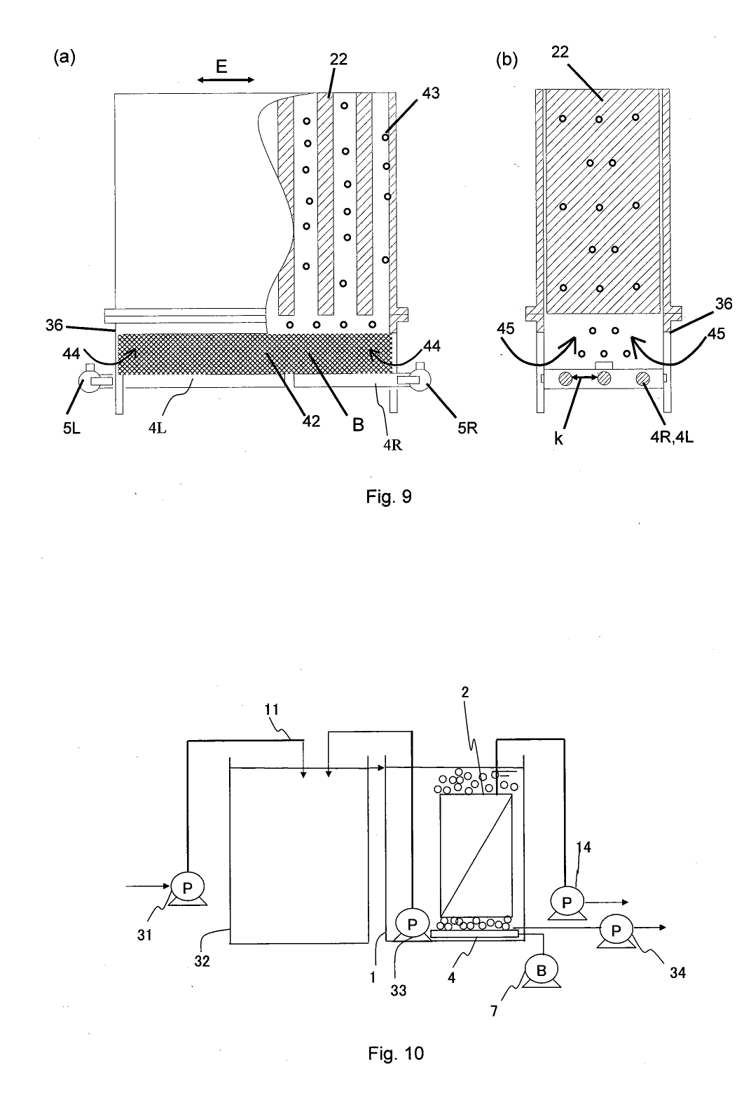

When a plurality of fine bubble diffusing tubes are arranged perpendicular to their longitudinal direction, they are preferably arranged at intervals of 80 to 200 mm. If they are arranged closer to one another at smaller intervals, the stream generated between the fine bubble diffusing tubes may be reduced, so that sludge may be more likely to be deposited on the upper portions of the fine bubble diffusing tubes. Particularly when the space between the diffusing tubes is extremely narrow during diffusing, the stream may be held in the space below the diffusing tubes so that sludge may be more likely to be retained. The sludge retention causes degradation in the properties due to an increase in the MLSS concentration or sludge viscosity under the diffusing tubes, and also makes the sludge anaerobic due to a reduction in the dissolved oxygen concentration. As a result, the sludge with the degraded properties is deposited and solidified on the diffusing tubes to cause a reduction in the diffusion amount or clogging of gas-diffusing holes, so that uneven diffusion or a reduction in diffusion efficiency may occur, which has an adverse effect on the membrane surface cleaning. If the horizontal distance between the diffusing tubes is too long so that it exceeds 200 mm, the gas discharged from the diffusing tubes may be less likely to be distributed throughout the membrane element, so that the membrane surface cleaning may tend to be uneven. For example, the horizontal distance between the diffusing tubes corresponds to the distance indicated by the letter k in FIG. 9(b).

The supply of gas to the opposed gas supply pipes may be achieved by dividing the gas supplied from a single gas supply unit or by supplying gas from separate gas supply units such as blowers in communication with the gas supply pipes, respectively. The amount of the gas supplied to the plurality of gas supply pipes should be optimized, and an imbalance between the amounts of the gas from the respective diffusing tubes due to unbalanced pressure loss should be reduced. In order to do so, the gas should preferably be supplied from separate gas supply units, respectively. When the gas supplied from a single gas supply unit is divided into parts, flow rate control means may be provided downstream of the dividing means so that unbalanced pressure loss can be cancelled.

The amount of the gas diffused from the fine bubble diffusing tubes is preferably controlled so that the flow rate of the aeration per horizontal cross-sectional area of the separation membrane module placed above the fine bubble diffusing tubes can be 0.9 m³/m²/minute or more. The term “horizontal cross-sectional area of the separation membrane module” refers to the space occupied by a plurality of separation membrane elements housed and arranged in the separation membrane module. If the flow rate of the aeration is less than that, the diffusion flow rate may be uneven so that it may be difficult to clean all the membrane surfaces.

The structure of the fine bubble diffusing tube for use in an embodiment of the invention is not particularly limited. For example, the fine bubble diffusing tube to be used may have a bubble discharge portion made of metal, ceramic, porous rubber, or a membrane, and a fine bubble diffuser may be used to increase the efficiency of oxygen dissolution into water. For example, the fine bubble diffusing tube may have a gas-diffusing hole portion made of a non-elastic material such as a metal tube. As shown in FIG. 2, however, the fine bubble diffusing tube preferably has a function such that fine bubbles are generated outside the diffusing tube when a small slit part of an elastic sheet is opened.

When the gas-diffusing hole portion is made of a non-elastic material such as a metal tube, the gas-diffusing hole diameter is preferably from 1.0 μm to 2.0 mm, more preferably from 1.0 μm to 500 μm. The gas-diffusing hole diameter may be a value determined by direct measurement. When the gas-diffusing hole is circular, the diameter of the circle may be defined as the hole diameter. When it is not circular, the effective area of the hole may be calculated using its photograph, and the diameter of a circle having the same area may be determined as the hole diameter. Specifically, when the hole has an effective area A, the hole diameter may be determined to be 2(A/π)^{1/2}. When there are a plurality of holes with different diameters, the average of the respective hole diameters may be determined as the gas-diffusing hole diameter.

Alternatively, the fine bubble diffusing tube may have a function such that fine bubbles are generated outside the diffusing tube when a small slit part of an elastic sheet is opened. FIG. 2 (a longitudinal sectional view along the longitudinal central axis α) shows an example of the structure of such a fine bubble diffusing tube, which includes at least a cylindrical supporting tube 17 and an elastic sheet 16 having fine slits, wherein the elastic sheet 16 is so placed that the periphery of the supporting tube 17 is covered with the sheet 16, and when gas is supplied to between the elastic sheet 16 and the supporting tube 17, the fine slits of the elastic sheet 16 are opened so that fine bubbles can be generated outside the diffusing tube.

The structure and mechanism of the fine bubble diffusing tube are more specifically described with reference to FIG. 2. The fine bubble diffusing tube includes the supporting tube 17 at the center and the elastic sheet 16 provided in such a manner that the whole periphery of the supporting tube 17 is covered with the sheet 16. Both ends of the elastic sheet 16 in the axial direction are fixed using ring-shaped fixing members 18. The elastic sheet 16 has a plurality of gas-diffusing slits (not shown). The longitudinal length of each gas-diffusing slit may be from 0.1 to 10 mm, in particular, preferably from 0.5 to 5 mm.

In this structure, one end of the supporting tube 17 is connected to the branch pipe portion 6, and a through hole 19 is formed in the vicinity of the connected end. Air supplied from the branch pipe 6 is allowed to pass through the through hole 19 and then introduced between the supporting tube 17 and the elastic sheet 16 to expand the elastic sheet 16. Upon the expansion of the elastic sheet 16, the gas-diffusing slits are opened, so that the supplied air is discharged in the form of fine bubbles into the liquid to be treated in the treatment tank. When the air supply is stopped, the elastic sheet 16 contracts to close the gas-diffusing holes. Therefore, when fine bubbles are not discharged, the liquid to be treated is prevented from flowing into the diffusing tube through the gas-diffusing holes, so that sludge can be prevented from causing clogging of the gas-diffusing holes or fouling of the interior of the diffusing tube in the course of the filtration operation.

The long fine bubble diffusing tube 4b and the short fine bubble diffusing tube 4a have the same structure, except for the longitudinal length.

The main gas-supply pipe 9, the gas supply pipe 5, the branch pipe portion 6, and the supporting tube 17 may each be made of any material that has such stiffness that it is not broken by such a load as a vibration caused by the diffusion. Preferred examples of such a material include metals such as stainless steel, resins such as acrylonitrile-butadiene-styrene rubber (ABS resin), polyethylene, polypropylene, and polyvinyl chloride, composite materials such as fiber-reinforced resins (FRP), and so on.

The material for the elastic sheet 16 is also not particularly limited. Synthetic rubber such as ethylene propylene rubber (EPDM), silicone rubber or urethane rubber, or any other elastic material may be appropriately selected and used to form the elastic sheet 16. In particular, ethylene propylene rubber is preferred, because of its high chemical resistance.

While the gas diffusing unit according to the embodiment shown in FIG. 1 includes two types of fine bubble diffusing tubes 4a, 4b different in longitudinal length (three diffusing tubes of each type, six diffusing tubes in total), the longitudinal length type and the number of the diffusing tubes are not limited thereto and may be arbitrarily selected, depending on the volume of the treatment tank 1, the size of the separation membrane module 2, the number of the separation membrane elements 22, or the flexibility of the design of the line or the like. The same applies to the other embodiments described below.

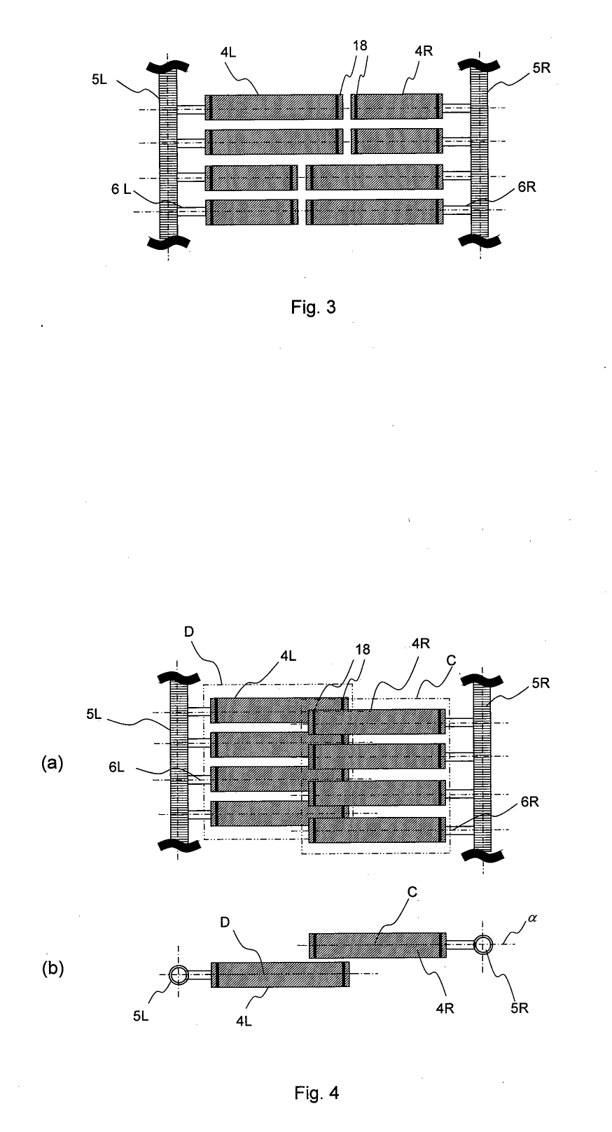

Next, another embodiment of the invention is shown in FIG. 3 (a top view of diffusing tube portions). In this structure, the longitudinal lengths of the adjacent fine bubble diffusing tubes 4 are staggered every two rows. Therefore, the longitudinal lengths of the adjacent fine bubble diffusing tubes 4 do not have to be staggered every row and may be staggered every two or more rows. Also in such an arrangement, fine bubble diffusing holes can be distributed over the region vertically below the spaces between the separation membrane elements so that bubbles can be introduced into all the spaces between the separation membrane elements to sufficiently clean the membrane surfaces.

A further embodiment of the invention is shown in FIG. 4 (top and side views (a), (b) of diffusing tube portions). The front end portion of a fine bubble diffusing tube extending from the left side and connected to a branch pipe portion 6L from a left gas supply pipe 5L overlaps the front end portion of a fine bubble diffusing tube extending from the right side and connected to a branch pipe portion 6R from a right gas supply pipe 5R. Specifically, the fine bubble diffusing tube extending from the right side and connected to the right branch pipe portion 6R has a longitudinal central axis a placed on a horizontal plane C, while the fine bubble diffusing tube extending from the left side and connected to the left branch pipe portion 6L has a longitudinal central axis a placed on a horizontal plane D under the horizontal plane C. In this case, the longitudinal central axis a of the upper fine bubble diffusing tube is preferably shifted from the longitudinal central axis of the lower fine bubble diffusing tube so that the upward-moving stream of fine bubbles discharged from the lower fine bubble diffusing tube will not be inhibited. As described above, the front end portions of the fine bubble diffusing tubes may overlap one another in the vertical direction in such a manner that the longitudinal central axes of the fine bubble diffusing tubes are not on the same plane. Also in such an arrangement, fine bubble diffusing holes can be distributed over the region vertically below the spaces between the separation membrane elements so that bubbles can be introduced into all the spaces between the separation membrane elements to sufficiently clean the membrane surfaces.

When the submerged membrane separation apparatus of the invention has a structure including a plurality of fine bubble diffusing tubes placed vertically below a separation membrane module, it may have a structure as shown in FIGS. 8 and 9, which is basically composed of a membrane module 2 having a plurality of membrane elements 22 arranged in the horizontal direction, fine bubble diffusing tubes 4 placed under the membrane elements 22, and a frame 36 surrounding the diffusing tubes and the space around them. The frame is placed so as to support the membrane module. The apparatus structure is preferably such that the ratio B/A is from 0.8 to 5.0, wherein B is the area of the openings of sides of the space surrounded by the frame 36, the sides being parallel to the direction of the arrangement of the membrane elements 22 and located above the diffusing tubes 4, and A is the area of the openings of the upper portions of the arranged membrane elements.

The term “the direction of the arrangement” refers to the direction in which the membrane elements 22 are arranged, which corresponds to the direction of the arrow E in FIG. 9. The area B of the openings above the diffusing tubes 4 corresponds to the sum of the areas of the portions suggested by reference numeral 42 in FIG. 9(a). Since the portions suggested by reference numeral 42 in FIG. 9(a) include front and back side portions, the opening area B is twice the area of the portion directly indicated by reference numeral 42. In FIG. 8, the area A of the openings of the upper portions of the membrane element is the sum of the areas (total area) of the spaces 41 between the membrane elements (the areas of the top faces).

As described above, it is preferred that the upper portion placed above the diffusing tubes and formed of the space surrounded by the frame be made wider than that of the conventional apparatus and that the area ratio (B/A) be from 0.8 to 5.0, particularly from 0.8 to 3.0. When the diffusing tubes 4 are located in such a position, turning flows 45 turning above the diffusing tubes 4 can be efficiently formed, and a large path can be ensured for the turning flows 45, so that a sufficiently high speed stream of the gas-liquid mixture can be supplied to the membrane surface of each membrane element 22 even when fine bubble diffusing tubes are provided (FIG. 9(b)).

The diffusing tubes 4 placed and fixed in the space surrounded by the frame 36 are fine bubble diffusing tubes capable of generating fine bubbles.

In addition, the distance between the lower end of the membrane element 22 and the diffusing tube 4 is preferably 300 mm or less so that the turning flows 45 can be efficiently formed. The distance between the membrane element 22 and the diffusing tube 4 refers to the distance between the lowermost end of the membrane element 22 and the uppermost end of the gas discharge portion of the diffusing tube. The distance is more preferably from 200 to 300 mm.

In an embodiment of the invention, the separation membrane provided in the separation membrane element 22 is a flat membrane, which can function to trap substances with particle sizes of a certain value or more contained in the liquid to be treated, when a pressure is applied to the liquid to be treated or when the filtrate side is under suction. While flat membranes are classified into dynamic filtration membranes, microfiltration membranes, and ultrafiltration membranes according to the size of particles to be trapped, microfiltration membranes are preferred.

From the viewpoint of high permeability and operation stability, the separation membranes to be used preferably have high water permeability. The pure water permeability coefficient of the separation membrane before use may be used as an index of the permeability. The pure water permeability coefficient may be a value that is calculated by measuring the amount of permeated water, using purified water with a head height of 1 m produced by reverse osmosis membrane treatment. The pure water permeability coefficient is preferably 2×10⁻⁹ m³/m²/s/pa or more, more preferably 40×10⁻⁹ m³/m²/s/pa or more. In this range, a practically sufficient amount of permeated water can be obtained.

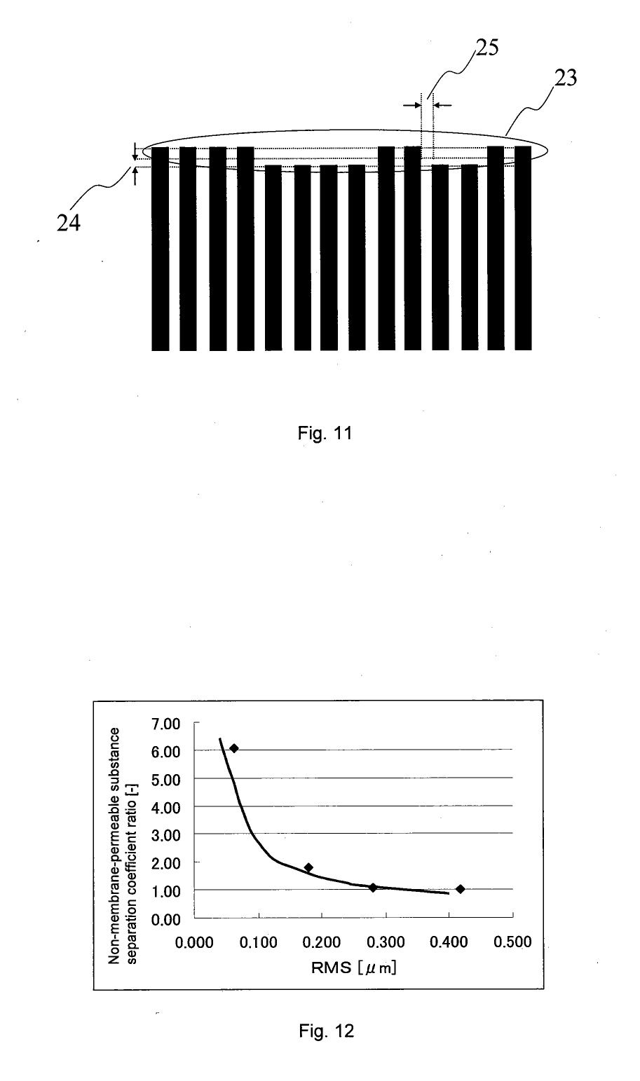

FIG. 11 schematically shows the surface portions of flat membranes used as the separation membranes. In a membrane separation activated sludge process, activated sludge is subjected to solid-liquid separation at membrane surface layer portions, and separated water is permeated through the membrane to form filtrated water (treated water). In the apparatus of the invention, the separation membrane to be used preferably has a smooth surface with small surface roughness such as a surface roughness of 0.1 μm or less, more preferably 0.001 to 0.08 μm, particularly preferably 0.01 to 0.07 μm. In addition, the separation membrane preferably has an average surface pore size of 0.2 μm or less, more preferably 0.01 to 0.15 μm, particularly preferably 0.01 to 0.1 μm. When such a separation membrane is used, the membrane surface cleaning effect can be sufficiently obtained even with fine bubbles, which have been considered to have a low cleaning effect, so that a stable operation can be achieved under normal flux conditions, which are required in the membrane separation activated sludge process.

The membrane surface roughness may be the average height of the surface profile of the separation membrane to be brought into contact with the liquid to be treated. In the schematic diagram of FIG. 11, it may be represented by the height indicated by reference numeral 24. The membrane surface roughness may be measured using the device and method described below. An atomic force microscope (Nanoscope IIIa manufactured by Digital Instruments) is used as a measuring device together with a SiN cantilever as a probe (manufactured by Digital Instruments) in a contact scanning mode with a scanning area of 10 μm×25 μm at a scanning resolution of 512×512. The height (represented by Zi) in the Z axis direction (the direction perpendicular to the membrane surface) is measured at each point to give data. Before the measurement, the membrane sample is subjected to pretreatment which includes immersing it in ethanol at room temperature for 15 minutes, then immersing it in reverse osmosis-treated water for 24 hours to wash it, and then drying it with air. Leveling of the baseline is performed for the measured data, and a root-mean-square (RMS) roughness (μm) is calculated according to formula 1 as the surface roughness of the membrane surface layer portion.

$$RMS = \sqrt{\frac{{\sum }_{i}^{N} {( Zi - \overline{Z} )}^{2}}{N}} \qquad formula 1$$

The average pore size of the membrane surface is the average size of the pores of the separation membrane surface. In the schematic diagram of FIG. 11, it may correspond to the width represented by reference numeral 25. For example, the average pore size of the membrane surface may be determined by a process including photographing the membrane surface with a scanning electron microscope at a magnification of 10,000×, measuring the diameters of any ten or more, preferably 20 or more pores, and number-averaging the diameters. When the pores are not circular, circles (equivalent circles) each having the same area as that of each pore may be determined, and the diameters of the equivalent circles may be determined as the diameters of the pores. If the standard deviation a of the pore size is too large, the ratio of pores with low filtration performance will be relatively high. Therefore, the standard deviation a is preferably 0.1 μm or less.

When flat membranes with such a surface profile are used as separation membranes in the membrane separation apparatus, the membrane surfaces can be well cleaned by the action of fine bubbles on the membrane surfaces. The reason may be considered as follows.

As shown in FIG. 12 (a graph plotted with membrane surface roughness (RMS) as the abscissa axis and with non-membrane-permeable substance separation coefficient ratio as the ordinate axis), the non-membrane-permeable substance separation coefficient ratio tends to increase as the surface roughness of the separation membrane decreases. The non-membrane-permeable substance separation coefficient of the membrane surface is a coefficient indicating the degree of easiness of separation of non-membrane-permeable substances from the separation membrane after deposition of the non-membrane-permeable substances from the liquid to be treated onto the separation membrane surface. The non-membrane-permeable substance separation coefficient ratio is the ratio of the separation coefficient of the sample membrane to the separation coefficient of a standard membrane. Therefore, a higher separation coefficient ratio means that the non-membrane-permeable substances deposited on the separation membrane is more easily separated from the separation membrane so that a non-membrane-permeable substance cake layer is less likely to be formed on the membrane surface, which means higher membrane filtration performance. In this regard, Durapore Membrane Filter VVLP02500 (made of hydrophilic PVDF, 0.10 μm in pore size) manufactured by Millipore is used as the standard membrane.

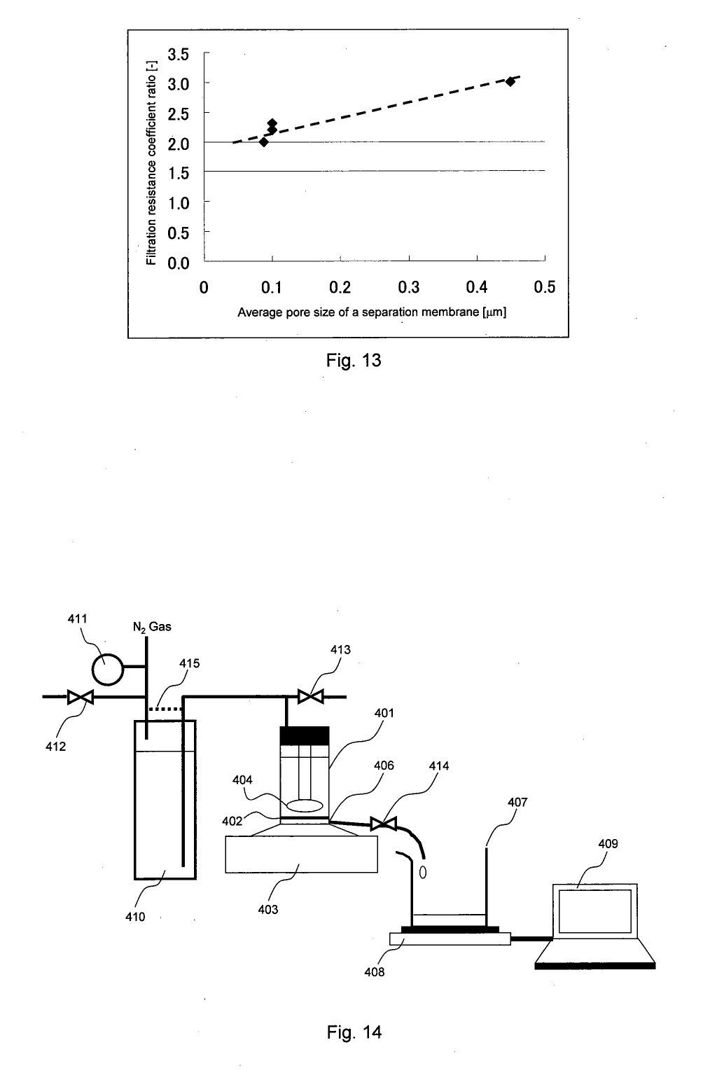

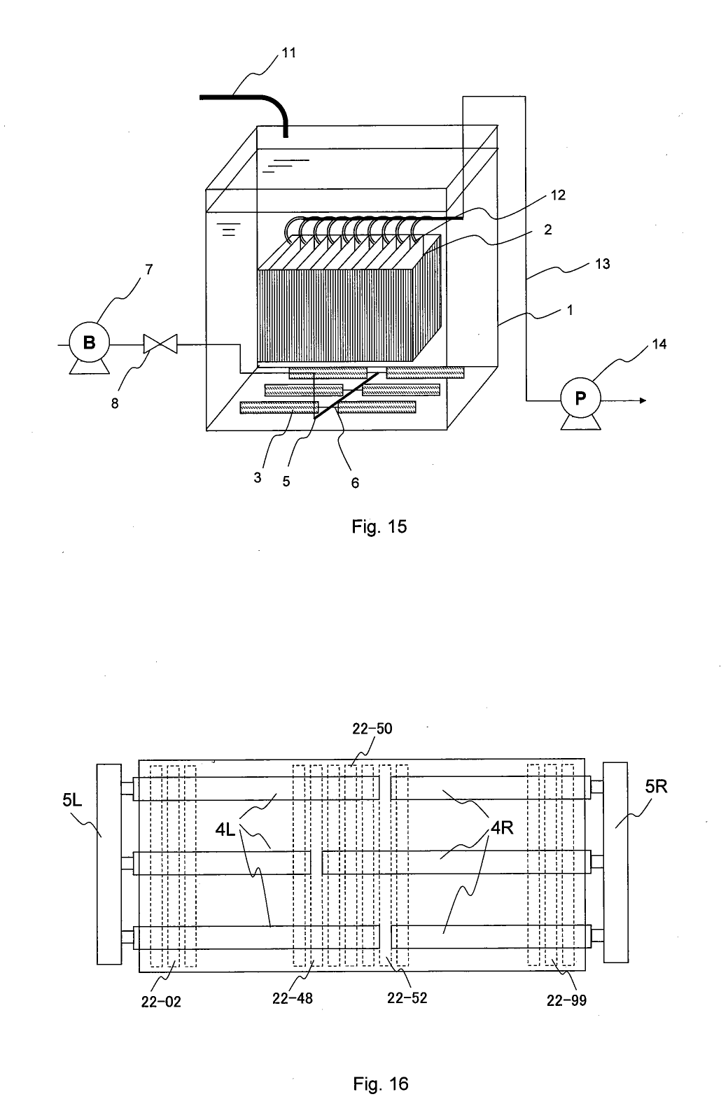

In addition, as shown in FIG. 13 (a graph plotted with average pore size of membrane surface as the abscissa axis and with filtration resistance coefficient ratio as the ordinate axis), the filtration resistance coefficient ratio tends to decrease as the average pore size of the separation membrane decreases. The filtration resistance coefficient ratio is the ratio of the filtration resistance coefficient of the separation membrane to that of a standard membrane, wherein the filtration resistance coefficient indicates the amount of resistance generated per unit amount of the non-membrane-permeable substance deposited on the membrane' surface. Therefore, a lower filtration resistance coefficient ratio means that the deposition of the non-membrane-permeable substance on the separation membrane surface is less likely to cause membrane filtration resistance, which means higher water permeability.

When fine bubbles rather than coarse bubble are generated from the gas diffusing unit and used to act on the membrane surface, the membrane surface cleaning stress excited by the upward-moving stream of the gas-liquid mixture is relatively low. When a separation membrane with a surface roughness of 0.1 μm or less is used, however, the non-membrane-permeable substance deposited on the separation membrane surface can be easily separated therefrom, because of its high non-membrane-permeable substance separation coefficient ratio, and a non-membrane-permeable substance cake layer is less likely to be formed on the membrane surface, so that sufficient membrane filtration performance can be obtained even when fine bubbles are used to clean the membrane surface.

The features shown in FIGS. 12 and 13 have been found as a result of membrane filtration experiments and analyses performed using the test apparatus shown in FIG. 14 with four commercially-available separation membranes different in membrane surface roughness and average pore size.

In the membrane filtration test apparatus shown in FIG. 14, a pure water chamber 410 containing pure water or a stirred cell 401 (Amicon 8050 manufactured by Millipore) is pressurized with nitrogen gas, while the pressure is measured with a pressure gauge 411. The liquid to be filtered is pressurized with the nitrogen gas and filtered through a separation membrane 402 placed in a membrane fixation holder 406. In the membrane filtration, the stirrer bar 404 is rotated with a magnetic stirrer 403 so that the liquid to be filtered is stirred in the stirred cell 401. The membrane filtrate through the separation membrane 402 is received in a beaker 407 placed on an electronic balance 408, and the amount of the membrane filtrate is measured with the electronic balance 408. The measured value is input into a personal computer 409. The presence or absence of the pressurization of each part of the membrane filtration test apparatus is controlled by opening or closing any of valves 412, 413 and 414.

Membrane filtration resistance is calculated using pure water in the membrane filtration test apparatus described above.

Next, an activated sludge liquid (collected from a membrane separation type activated sludge process unit being used to treat agricultural community drainage) is subjected to membrane filtration with the separation membrane so that a filtration resistance coefficient can be determined. This membrane filtration is performed using the membrane filtration test apparatus, except that the pure water chamber 410 is detached from the apparatus, a connecting pipe 415 is connected as indicated by the dotted line in FIG. 14, and the membrane filtration is performed without stirring by the magnetic stirrer 403. The filtration resistance coefficient is measured using each of a standard membrane and a sample membrane, and the filtration resistance coefficient ratio αᵣ is calculated according to formula 2 below.

$${α}_{r} = \frac{{α}_{m}}{{α}_{s}} \qquad formula 2$$

In the formula, αₘ is the filtration resistance coefficient of the sample membrane, and αₛ is the filtration resistance coefficient of the standard membrane.

Next, a membrane filtration test is performed in the same manner as in the case of the filtration resistance coefficient so that a non-membrane-permeable substance separation coefficient can be determined. In this membrane filtration test, however, membrane filtration is performed under stirring. The membrane filtration is temporarily stopped in the middle, and the data showing the relationship between the time obtained by the membrane filtration and the amount of the membrane-filtered liquid are used to form the relationship between the membrane filtration resistance and the total filtered liquid amount per unit membrane area in the same manner as described above.

On the other hand, the relationship between the membrane filtration resistance and the total filtered liquid amount per unit membrane area is reproduced by the following membrane filtration resistance prediction method. The mathematical formulae below are used in the membrane filtration resistance prediction method.

$$\begin{matrix}J ( t ) = \frac{Δ P}{μ \cdot R ( t )} & formula 3 \\ Xm ( t + 1 ) = Xm ( t ) + ( \begin{matrix}\begin{matrix}X ( t ) \cdot J ( t ) - γ \cdot \\ ( τ - λ \cdot Δ P ) \cdot \end{matrix} \\ ( η Xm ( t ) ) \cdot Xm ( t )\end{matrix} ) \cdot Δ t & formula 4 \\ R ( t ) = Rm + α \cdot Xm ( t ) & formula 5 \\ X ( 0 ) \cdot V ( 0 ) = X ( t ) \cdot V ( t ) + Xm ( t ) \cdot A & formula 6 \\ V ( t ) = V ( 0 ) - A \cdot {\int }_{0}^{t} J ( t ) d t & formula 7\end{matrix}$$

In the formulae, J(t) is the membrane filtration flux (m/s) at the time t, R(t) is the membrane filtration resistance (l/m) at the time t, Xm(t) is the amount (g/m²) of the solid component deposited on unit membrane area at the time t, X(t) is the amount (g/m³) of the solid component in the liquid to be filtered at the time t, γ is the non-membrane-permeable substance separation coefficient (l/m/s), τ is the membrane cleaning ability (−), λ is the friction coefficient (l/Pa), η is the reciprocal (m³/g) of the density, Δt is the increment (s) at the time t, Rm is the initial value (l/m) of the membrane filtration resistance, V(t) is the volume (m³) of the liquid to be filtered at the time t, and A is the effective membrane area (m²), wherein τ=1, η=1×10⁻⁶, the filtration resistance coefficient α to be used is as determined above, and the membrane filtration resistance determined above for pure water is used as Rm.

The calculations of formulae 3 to 7 are repeated, while the time is renewed, so that the membrane filtration flow rate and the membrane filtration resistance at each time are calculated. As a result, predictive values are obtained for the relationship between the membrane filtration resistance and the total filtered liquid amount per unit membrane area. Using various non-membrane-permeable substance separation coefficients and friction coefficients, therefore, predictive values are calculated for the relationship between the membrane filtration resistance and the total filtered liquid amount per unit membrane area. A non-membrane-permeable substance separation coefficient and a friction coefficient that make the difference from the actual measurement minimal are selected and determined as the non-membrane-permeable substance separation coefficient and friction coefficient of the separation membrane.

The non-membrane-permeable substance separation coefficients of the standard membrane and the sample membrane are calculated as described above, and the non-membrane-permeable substance separation coefficient ratio γᵣ is calculated according to formula 8 below.

$${γ}_{r} = \frac{{γ}_{m}}{{γ}_{s}} \qquad formula 8$$

In the formula, γₘ is the non-membrane-permeable substance separation coefficient of the sample membrane, and γₛ is the non-membrane-permeable substance separation coefficient of the standard membrane.

The flat separation membrane with the smooth surface profile specified herein may be produced by a process including applying a membrane-forming material liquid containing a polyvinylidene fluoride resin, a pore-forming agent, and so on to one or both sides of a base material of a nonwoven fabric, and immediately solidifying the material liquid in a solidifying liquid containing a non-solvent so that a porous separation-functional layer is formed. The conditions described below may also be used.

In the process of solidifying the membrane-forming material liquid, only the porous separation-functional layer formed on the base material may be brought into contact with the solidifying liquid, or the porous separation-functional layer may be immersed together with the base material in the solidifying liquid.

Besides the polyvinylidene fluoride resin, the membrane-forming material liquid may also contain a pore-forming agent, a solvent to dissolve them, and so on, as needed. When a pore-forming agent having the effect of accelerating pore formation is added to the membrane-forming material liquid, the pore-forming agent to be used should be extractable with the solidifying liquid and have high solubility in the solidifying liquid. Examples of the pore-forming agent that may be used include polyoxyalkylenes such as polyethylene glycol and polypropylene glycol, water-soluble polymers such as polyvinyl alcohol, polyvinyl butyral and polyacrylic acid, and glycerin. The desired porous structure can be more easily obtained using such a surfactant.

The membrane-forming material liquid may also contain a solvent to dissolve the polyvinylidene fluoride resin, any other organic resin, and a pore-forming agent or the like. In such a case, examples of solvents that are preferably used include N-methylpyrrolidone (NMP), N,N-dimethylacetamide (DMAc), N,N-dimethylformamide (DMF), dimethyl sulfoxide (DMSO), acetone, and methyl ethyl ketone. In particular, NMP, DMAc, DMF, and DMSO are preferably used, because the polyvinylidene fluoride resin is highly soluble in them. In addition, a non-solvent may also be added to the membrane-forming material liquid. The non-solvent does not dissolve the polyvinylidene fluoride resin or any other organic resin and acts to control the rate of the solidification of the polyvinylidene fluoride resin and any other organic resin so that the pore size can be controlled. Water, an alcohol such as methanol or ethanol, or the like may be used as the non-solvent. In particular, water or methanol is preferred in view of easiness of effluent treatment and cost.

For the composition of the membrane-forming material liquid, the contents of the polyvinylidene fluoride resin, the pore-forming agent, the solvent, and the non-solvent are preferably in the ranges of 5 to 30% by weight, 0.1 to 15% by weight, 45 to 94.8% by weight, and 0.1 to 10% by weight, respectively. In particular, the content of the polyvinylidene fluoride resin is preferably in the range of 8 to 20% by weight, because if its content is too low, the porous layer may have a reduced strength and because if its content is too high, the water permeability may be reduced. If the content of the pore-forming agent is too low, the water permeability may be reduced, and if its content is too high, the porous layer may have a reduced strength. If its content is extremely high, it may be left in an excess amount in the polyvinylidene fluoride resin so that it may be leached during use to degrade the quality of the permeate or cause fluctuations in the permeability. Therefore, the content of the pore-forming agent is preferably in the range of 0.5 to 10% by weight. If the content of the solvent is too low, the material liquid may be more likely to form a gel. If its content is too high, the porous layer may have a reduced strength. Therefore, its content is more preferably in the range of 60 to 90% by weight. If the content of the non-solvent is too high, the material liquid may be more likely to form a gel. If its content is too low, the pore size or the macrovoid size may be difficult to control. Therefore, its content is more preferably from 0.5 to 5% by weight.

The non-solvent-containing solidifying bath to be used may be a liquid of the non-solvent or a mixed solution containing the non-solvent and a solvent. When the membrane-forming material liquid contains a non-solvent, the content of the non-solvent in the solidifying bath is preferably at least 80% by weight of the solidifying bath. If its content is too low, the rate of solidification of the polyvinylidene fluoride resin may be too low, so that the surface roughness and the pore size may be too large. Particularly in order to form a separation-functional layer with a surface roughness of 0.1 μm or less, water is preferably used as the non-solvent, and the water content is preferably set in the range of 85 to 100% by weight.

On the other hand, when the membrane-forming material liquid does not contain any non-solvent, the content of the non-solvent in the solidifying bath is preferably lower than that in the case that the membrane-forming material liquid contains the non-solvent. For example, it is preferably from 60 to 99% by weight. If the content of the non-solvent is too high, the rate of solidification of the polyvinylidene fluoride resin may be too high, so that the porous layer may have a dense surface and therefore low water permeability.

As described above, the content of the non-solvent in the solidifying bath may be controlled so that the surface roughness, pore size or macrovoid size of the porous layer can be controlled. If the temperature of the solidifying bath is too high, the solidification rate may be too high. If it is too low, the solidification rate may be too low. Therefore, it is preferably selected in the range of 15 to 80° C., more preferably 20 to 60° C.

The production method described above allows the production of a separation membrane including a porous base material and a porous polyvinylidene fluoride resin layer formed on the surface of the base material, wherein the porous resin layer includes: a separation-functional layer having a smooth surface (with a surface roughness of 0.1 μm or less) and a desired average pore size (0.01 to 0.2 μm) necessary for membrane filtration formed in the outer surface side of the porous resin layer; and a macrovoid-containing layer formed inner than the separation-functional layer. Therefore, the porous resin layer includes: the macrovoid-containing layer existing in an inside portion close to the porous base material; and the separation-functional layer having the desired pore size and the smooth surface and existing in an outer surface portion.

### EXAMPLES

### Example 1

FIG. 6 shows a specific example of the membrane separation apparatus according to the invention. FIGS. 6(a), 6(b) and 6(c) are a front view, a side view, and an A-A cross-sectional view of the membrane separation apparatus, respectively. In the drawings, gas supply pipes and parts upstream thereof are omitted.

In the apparatus, 100 separation membrane elements are arranged parallel to one another in a separation membrane module 2. Fine bubble diffusing tubes extending in the horizontal direction from branch pipe portions 6R of a right gas-supply pipe (not shown) and fine bubble diffusing tubes extending in the horizontal direction from branch pipe portions 6L of a left gas-supply pipe (not shown) are placed vertically below the separation membrane module 2. The fine bubble diffusing tubes are arranged in four rows so that their longitudinal central axes α are substantially on the same horizontal plane and substantially aligned with a straight line in each row, and the front ends of the opposed fine bubble diffusing tubes are placed adjacent to each other. In addition, their front end portions are arranged in a staggered manner. The long fine bubble diffusing tube 4b has a longitudinal length of 0.8 m, and the short fine bubble diffusing tube 4a has a longitudinal length of 0.6 m. The arrangement and structure of the fine bubble diffusing tubes make it possible to uniformly diffuse fine bubbles across the membrane surface of each element in the separation membrane module 2.

### Example 2

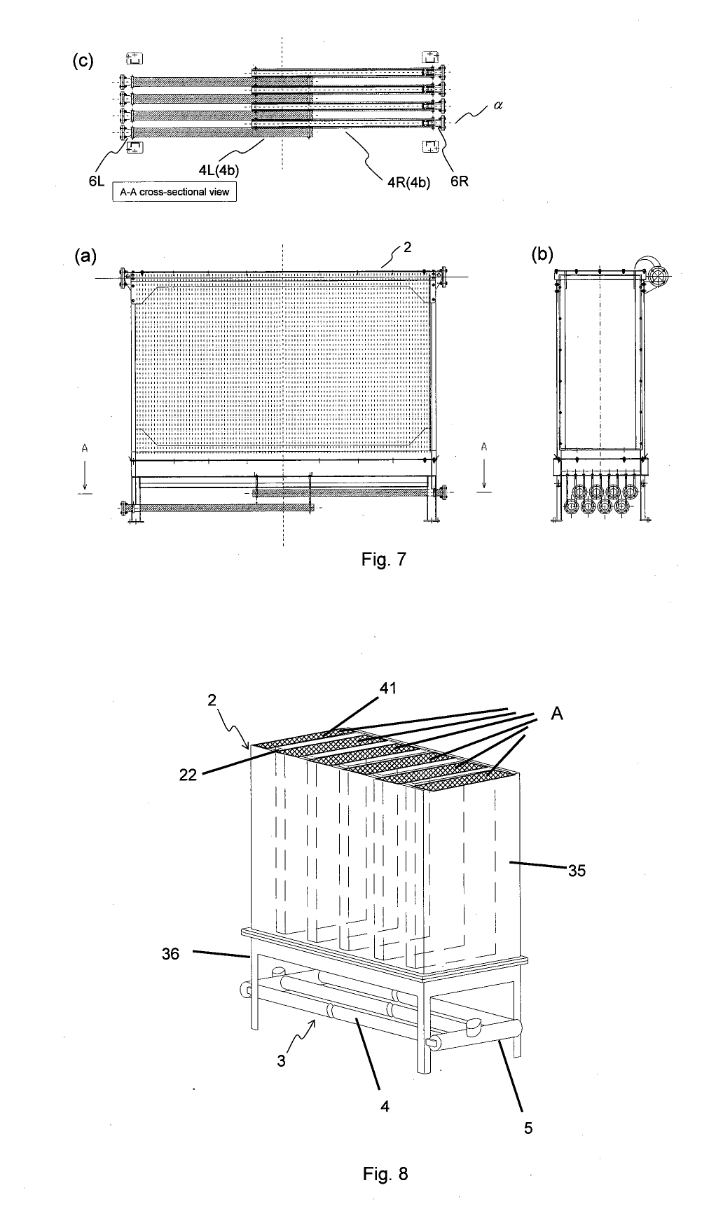

FIG. 7 shows another specific example of the membrane separation apparatus according to the invention. FIGS. 7(a), 7(b) and 7(c) are a front view, a side view, and an A-A cross-sectional view of the membrane separation apparatus, respectively. In the drawings, gas supply pipes and parts upstream thereof are omitted.

In the apparatus, the separation membrane module 2 has the same structure as that in Example 1, but the diffuser tube structure placed under the separation membrane module 2 differs from that in Example 1. Fine bubble diffusing tubes extending in the horizontal direction from branch pipe portions 6R of a right gas-supply pipe (not shown) and fine bubble diffusing tubes extending in the horizontal direction from branch pipe portions 6L of a left gas-supply pipe (not shown) are placed vertically below the separation membrane module 2. The fine bubble diffusing tubes used are all long fine bubble diffusing tubes 4b having a longitudinal length of 0.8 m. The fine bubble diffusing tubes are so arranged that their longitudinal central axes α are shifted from one another and placed on two (upper and lower) horizontal planes, and their front end portions overlap one another. The structure of the fine bubble diffusing tubes make it possible to uniformly diffuse fine bubbles across the membrane surface of each element in each separation membrane module 2.

### Example 3

Separation membranes (flat membranes) were placed on the front and back sides of a supporting ABS plate (1,000 mm high×500 mm wide×6 mm thick) having irregularities on both sides, which were used as an alternative to a channel member, so that a membrane element (0.9 m² in separation membrane area) was prepared. The separation membranes used were flat polyvinylidene fluoride membranes with an average surface pore size of 0.08 μm and a surface roughness (RMS) of 0.062 μm.

Next, a casing was formed, which had upper and lower openings and an interior size of 1,000 mm high×515 mm wide×1,400 mm long. A frame was joined to the lower end of the casing. Fine bubble diffusing tubes were fixed at the predetermined position in the interior of the frame, and the vertical distance between the lower end of the element and the fine bubble diffusing tube was 220 mm. In this structure, the area of the opening of one side being parallel to the direction of the arrangement of the membrane elements and located above the diffuser tubes was 2,520 cm². When 100 membrane elements were loaded into the casing, the area of the openings of the upper sides of the membrane elements was 4,000 cm² on the upper side of the casing. Therefore, the ratio B/A was 2,520×2/4,000=1.26.

The diffuser tubes used were six fine bubble diffusing tubes with a diameter of 70 mm having a large number of fine slits with a length of 2 mm. As shown in FIG. 8, air supply pipes 5 for supplying air to the diffuser tubes were fixed to the frame 36 so that the diffuser tubes could be placed at the predetermined position. The horizontal distance k between the diffuser tubes was 125 mm. Fine bubble diffusing tubes 4 having longitudinal lengths of 0.75 m and 0.65 m, respectively, were used and connected to the opposed air supply pipes 5. In each row, they were substantially aligned with a straight line and so arranged that their front ends were placed adjacent to each other. In addition, their front ends were alternately staggered. The sum of the longitudinal lengths of the fine bubble diffusing tubes connected to one air supply pipe 5 and the sum of the longitudinal lengths of the fine bubble diffusing tubes connected to the other air supply pipe 5 were 2.15 m and 2.05 m, respectively, and the difference between them was 5%.

As a result, a submerged membrane separation apparatus having the structure shown in FIG. 8 was fabricated, which had the 100 membrane elements 22 placed in the casing 35, the frame 36, and the diffuser tubes 4.

Domestic wastewater was treated under the conditions summarized in Table 1 according to the water purification process for the treatment apparatus shown in FIG. 10. FIG. 10 shows the membrane elements-containing separation membrane module 2 and the fine bubble diffusing tubes 4 of the submerged membrane separation apparatus in a simplified manner. As shown in FIG. 10, raw water (domestic wastewater) is first introduced into a denitrification tank 32 through a raw water supply pump 31 and mixed with activated sludge. The activated sludge mixture liquid is then introduced into an aeration tank 41. In the biological treatment process, a nitrification process (aerobic) and a denitrification process (anaerobic) are allowed to proceed so that nitrogen can be removed. Ammonia nitrogen (NH₄—N) is nitrated in the later aeration tank (aerobic tank) 41, and the nitrated liquid is fed back to the earlier denitrification tank 32 from the membrane separation activated sludge tank by a sludge circulating pump 33, so that nitrogen is removed in the denitrification tank 32.

In this system, air is blown from an air supply unit 7 and discharged for aeration through the diffuser 3. The activated sludge is kept in an aerobic state by the aeration so that nitrification reaction and BOD oxidation are carried out. In addition, the aeration makes it possible to clean the sludge, which may adhere or be deposited onto the membrane surfaces in the separation membrane module 2. The sludge was periodically drawn by a sludge drawing pump 34 so that the MLSS concentration in the aeration tank 41 and the denitrification tank 32 could be maintained.

The membrane filtration with the separation membrane module 2 was performed, while the permeate side was sucked by a suction pump 14. A timer was installed to prevent the deposition of the sludge on the separation membrane surfaces. According to the pre-recorded program, a relay switch was used to periodically switch ON/OFF of the suction pump so that the membrane filtration was performed in an intermittent operation mode including cycles of ON for 8 minutes and OFF for 2 minutes. During the operation, the membrane filtration flux was fixed at 1.0 m/day (average flux).

TABLE 1

| | Specifications |
|---|---|
| Type of raw water | Domestic wastewater |
| Quality of raw water | BOD (biological oxygen demand): 200 mg/L |
| (average) | TN (total nitrogen): 45 mg/L |
| | TP (total phosphorous): 8 mg/L |
| Water throughput | 24 m³/day |
| Volume of biological | Denitrification tank: 5 m³ |
| treatment tank | Membrane separation activated sludge tank: |
| | 5 m³ Total 10 m³ |
| Hydraulic retention | 10 hours(denitrification tank: 5 hours, membrane |
| time (HRT) | separation activated sludge tank: 5 hours) |
| Activated sludge | Membrane separation activated sludge tank |
| conditions | MLSS: 8,000 mg/L-15,00 0 mg/L |
| | Membrane separation activated sludge tank |
| | dissolved oxygen (DO): 0.5-2.0 mg/L |
| Amount of sludge | Three times the amount of the liquid to be treated: |
| circulation | 72 m³/day |
| Temperature of liquid | 13° C.-28° C. |
| to be treated | |
| Aeration amount | 10 L/min · EL × 100EL = 1000 L/min |

The membrane differential pressure was measured with time as an index of the operational performance, and the time course was used. If the turning flow is unevenly generated during the operation, the membrane differential pressure will increase to make a stable operation difficult. Therefore, variations in the membrane differential pressure may be used to evaluate the operational performance.

The operation was performed for 90 days. As a result, the rate of rise of the differential pressure was 0.07 kPa/day over 90 days, and it was possible to continue an almost stable operation (see Table 2).

### Example 4

In the same structure of the submerged membrane separation apparatus as that in Example 3, the position of the diffuser fixed to the frame was changed, so that the fine bubble diffusing tubes were placed in such positions that the vertical distance between the lower end of the membrane element and the diffuser was 120 mm, 155 mm or 460 mm. In such a structure, the B/A ratio was 0.56, 0.805 or 2.94, to which 4(a), 4(b) or 4(c) is assigned.

These membrane separation apparatuses were each used under the same operational conditions as those in Example 3. As a result, the rate of rise of the differential pressure was 1.08, 0.10 or 0.05 kPa/day. When the vertical distance between the lower end of the element and the diffuser was 120 mm (the case 4(a)), the differential pressure rapidly increased so that the operation became impossible after about 30 days. When the vertical distance between the lower end of the element and the diffuser was 155 mm (the case 4(b)) or 460 mm (the case 4(c)), it was possible to continue an almost stable operation.

TABLE 2

| | Example | | | |
|---|---|---|---|---|
| | 3 | 4(a) | 4(b) | 4(c) |
| Vertical distance between | 220 | 120 | 155 | 460 |
| the element lower end and | | | | |
| the diffuser | | | | |
| B/A | 1.26 | 0.56 | 0.805 | 2.94 |
| Rate of rise of | 0.07 | 1.08 | 0.10 | 0.05 |
| differential pressure | | | | |
| (kPa/day) | | | | |

### Example 5

In the same submerged membrane separation apparatus as that in Example 3 including 100 separation membrane elements, a water head difference of 270 mm was applied to the membrane elements 22 (the second element (22-02), the 48th element (22-48), the 50th element (22-50), the 52nd element (22-52), and the 99th element (22-99) from the end), when the membrane filtration flux was measured. FIG. 16 shows the vertical positional relation between the membrane elements and the fine bubble diffusing tubes. This structure has three fine bubble diffusing tubes 4L placed vertically below the membrane element 22-02, two fine bubble diffusing tubes 4L placed vertically below the membrane element 22-48, two fine bubble diffusing tubes 4L and one fine bubble diffusing tube 4R placed vertically below the membrane element 22-50, one fine bubble diffusing tube 4L placed vertically below the membrane element 22-52, and three fine bubble diffusing tubes 4L placed vertically below the membrane element 22-99.

After the filtration was performed for 5 minutes at an aeration flow rate of 1,000 L/minute (the aeration flow rate per separation membrane module was 1.38 m³/m²/minute), all the separation membrane elements showed a membrane filtration flux of 1.0 m/day, so that a sufficiently high membrane filtration flux was maintained.

After the filtration was performed for 5 minutes at an aeration flow rate of 700 L/minute (the aeration flow rate per separation membrane module was 0.97 m³/m²/minute), the separation membrane elements showed a membrane filtration flux of 1.0 m/day, except that the membrane element 22-52 showed a membrane filtration flux of 0.8 m/day. The single membrane element below which only one fine bubble diffusing tube was placed showed a slightly low membrane filtration flux, as compared with that of the other elements. Viewed as a whole, however, a sufficiently high membrane filtration flux was maintained.

After the filtration was performed for 5 minutes at an aeration flow rate of 500 L/minute (the aeration flow rate per separation membrane module was 0.69 m³/m²/minute), the separation membrane elements 22-02 and 22-99 showed a membrane filtration flux of 1.0 m/day, but the membrane elements 22-48 and 22-50 showed 0.7 m/day, and the membrane element 22-52 showed 0.5 m/day. As a result, the central membrane element showed a significantly low membrane filtration flux, as compared with that of other elements.

### INDUSTRIAL APPLICABILITY

The submerged membrane separation apparatus of the invention is suitable for use in an activated sludge process tank in treatment of polluted water such as sewage, excrement, or industrial wastewater. The submerged membrane separation apparatus of the invention may also be used to perform membrane separation of various types of water other than polluted water (such as clean water or tap water).

1. A submerged membrane separation apparatus submerged in a liquid to be treated in a treatment tank, comprising:
a separation membrane module comprising a plurality of separation membrane elements each having a flat membrane as a separation membrane, the plurality of separation membrane elements being arranged in parallel with their membrane surfaces being parallel to one another;
a plurality of fine bubble diffusing tubes placed vertically below the separation membrane module; and
a plurality of gas supply pipes for supplying gas to the fine bubble diffusing tubes, wherein
the plurality of gas supply pipes are opposed to each other so that a region vertically below the separation membrane module is held between them,
the plurality of fine bubble diffusing tubes are connected to the gas supply pipes and extend in a direction intersecting with the membrane surface of the separation membrane element,
the plurality of fine bubble diffusing tubes are arranged in a region vertically below the separation membrane module so that their longitudinal directions are substantially aligned with a straight line, and
(a) the front ends of the fine bubble diffusing tubes opposed to one another are placed adjacent to one another, and
the plurality of fine bubble diffusing tubes are arranged in rows in each of which the fine bubble diffusing tubes have different lengths and arranged in combination so that their front ends are not aligned between the rows, or
(b) the fine bubble diffusing tubes have same or different lengths and arranged so that the front ends of the fine bubble diffusing tubes opposed to one another are placed overlapping one another.

2. (canceled)

3. The submerged membrane separation apparatus according to claim 1, wherein the front ends of the fine bubble diffusing tubes substantially aligned with the straight line are staggered every row or every two or more rows.

4. (canceled)

5. The submerged membrane separation apparatus according to claim 1, wherein the difference between the sums of the longitudinal lengths of the fine bubble diffusing tubes connected to the opposed gas supply pipes is at most 10%.

6. The submerged membrane separation apparatus according to claim 1, wherein the plurality of fine bubble diffusing tubes are arranged at intervals of 80 to 200 mm in a direction perpendicular to their longitudinal axes.

7. The submerged membrane separation apparatus according to claim 1, wherein the gas is supplied from separate gas supply units to the opposed gas supply pipes, respectively.

8. The submerged membrane separation apparatus according to claim 1, wherein the fine bubble diffusing tube comprises at least a cylindrical supporting tube and an elastic sheet having fine slits, wherein the elastic sheet is so placed that the periphery of the supporting tube is covered with the elastic sheet, and the fine bubble diffusing tube has a function such that when gas is supplied to between the elastic sheet and the supporting tube, the fine slits of the elastic sheet are opened so that fine bubbles can be generated outside the diffusing tube.

9. The submerged membrane separation apparatus according to claim 1, further comprising a frame that is placed under the separation membrane module so as to support the separation membrane module, wherein
the fine bubble diffusing tubes are placed inside the frame, and
the ratio B/A is from 0.8 to 5.0, wherein B is the area of the openings of sides of the space surrounded by the frame, the sides being parallel to the direction of the arrangement of the membrane elements and located above the fine bubble diffusing tubes, and A is the area of the openings of the upper side of the membrane separation module.

10. The submerged membrane separation apparatus according to claim 1, wherein the separation membrane is a flat membrane comprising a base material layer comprising a nonwoven fabric and a porous separation-functional layer made of polyvinylidene fluoride and formed on the base material layer, wherein the porous separation-functional layer has an average pore size of at most 0.2 μm, and the membrane has a surface roughness of at most 0.1 μm.

11. A method for operating a submerged membrane separation apparatus, comprising:
submerging the submerged membrane separation apparatus according to claim 1 in a liquid to be treated in a treatment tank;
performing aeration from the fine bubble diffusing tubes; and
performing a membrane filtration operation, wherein
the flow rate of the aeration per horizontal cross-sectional area of the separation membrane module, supplied to the fine bubble diffusing tubes, is at least 0.9 m³/m²/minute.
